(19) United States
(12) Patent Application Publication
(10) Pub. No.: US 2017/0206059 A1
(43) Pub. Date: Jul. 20, 2017

(54) APPARATUS AND METHOD FOR VOICE RECOGNITION DEVICE IN VEHICLE

(71) Applicant: HYUNDAI MOTOR COMPANY, Seoul (KR)

(72) Inventor: Woo Sok YANG, Gwangmyeong-si (KR)

(21) Appl. No.: 15/179,245

(22) Filed: Jun. 10, 2016

(30) Foreign Application Priority Data
Jan. 15, 2016 (KR) 10-2016-0005294

(51) Int. Cl. G06F 3/16; G10L 15/32; G10L 17/02

(52) U.S. Cl. CPC G06F 3/167; G10L 17/02; G10L 15/32; G10L 2015/223

(57) ABSTRACT

A method is for controlling an apparatus included in a vehicle with a voice recognition device. The method includes receiving and recognizing a voice instruction, performing an upper level operation corresponding to the voice instruction, receiving a non-voice input for performing a lower level operation appertaining to the upper level operation, and performing the lower level operation in response to the non-voice input.

### CROSS-REFERENCE TO RELATED APPLICATION

This application claims priority to and the benefit of Korean Patent Application No. 10-2016-0005294, filed on Jan. 15, 2016 in the Korean Intellectual Property Office, the disclosure of which is hereby incorporated by reference as if fully set forth herein.

### TECHNICAL FIELD

The disclosure relates to an apparatus and a method for voice recognition device includable in, or engaged with, a vehicle, and more particularly, to an apparatus and a method for using a combination of user's voice instruction and interface manipulation to control or use electric devices in the vehicle.

### BACKGROUND

Recently, there has been a trend to apply dramatically developed information technology (IT), like other products or apparatuses, to a vehicle. Consumers not merely use a particular IT service via their mobile devices but also try to use a customized IT service via various systems or apparatuses including the vehicle. Accordingly, a technique regarding connectivity between the vehicle and a smart phone has been suggested. An example is a technology for engagement between a smart phone and an audio-video-navigation (AVN) device included in the vehicle. On the market, there are Apple CarPlay and Android Auto which are provided by Apple Inc. and Google Inc. playing an essential role in distributing software, hardware or operating systems used for a mobile device.

Apple CarPlay and Android Auto involve a function of performing a particular operation in response to user's voice instruction via voice recognition technologies. The function included in both Apple CarPlay and Android Auto is provided in lieu of user interfaces. However, since there is a limit in terms of user's voice instructions based on voice recognition technologies, user interfaces are not completely replaced with user's voice instructions so that a user could feel inconvenience.

### SUMMARY

An apparatus and a method for compensating a user for inconvenience caused by simplicity in terms of user's voice instructions based on voice recognition technologies by using user interfaces included in a vehicle.

Further, an apparatus and a method for combining recognized voice inputs with inputs via user interfaces can be used for performing a particular operation in response to user's request which is more complex than recognized voice instructions or user interfaces provided in a vehicle.

A method for controlling an apparatus included in a vehicle with a voice recognition device can include receiving and recognizing a voice instruction, performing an upper level operation corresponding to the voice instruction, receiving a non-voice input for performing a lower level operation appertaining to the upper level operation, and performing the lower level operation in response to the non-voice input.

The non-voice input can be entered via a button or a touch screen equipped in a vehicle.

The non-voice input can be recognized after the voice instruction is recognized until the upper level operation is completely done.

The upper level operation can be maintained for a predetermined time after the lower level operation is done.

The method can further include receiving a new non-voice input for performing another lower level operation appertaining to the upper level operation within a predetermined time after the lower level operation is done.

The upper level operation can include a main function of playing received messages while the lower level operation can include at least one of plural sub functions of replaying, rewinding, fast-forwarding, skipping, deleting and storing a message, which appertain to the main function.

The method can further include engaging with a mobile device through a local area wireless network.

The upper level operation and the lower level operation activated by the voice instruction and the non-voice input are for running a vehicle engagement application installed in the mobile device.

The method can further include receiving the non-voice input via the mobile device.

The step of performing an upper level operation can include determining which upper level operation corresponds with the voice instruction, determining a factor, which is not recognized from or included in the voice instruction but necessary to perform the upper level operation, based on a predetermined set or value, and performing the upper level operation based on the voice instruction and the factor.

The factor can include at least one of information regarding a time, a date, a place and a sender, when the upper level operation can include a function of playing received messages.

An apparatus can provided for controlling an apparatus included in a vehicle with a voice recognition device. The apparatus can include a voice instruction receiver configured to receive and recognize a voice instruction used for controlling an electric device equipped in, or engaged with, the vehicle, a controller configured to perform an upper level operation according to the voice instruction, and a non-voice input receiver configured to receive a non-voice input for performing a lower level operation appertaining to the upper level operation. Herein, the controller can perform the lower level operation in response to the non-voice input.

The apparatus can further include a microphone configured to deliver the voice instruction, and at least one of a touch screen and a button configured to deliver the non-voice instruction.

The non-voice input can be recognized after the voice instruction is recognized until the upper level operation is completely done.

The upper level operation can be maintained for a predetermined time after the lower level operation is done.

The non-voice input receiver can recognize a new non-voice input for performing another lower level operation appertaining to the upper level operation within the predetermined time after the lower level operation is done.

The upper level operation can include a main function of playing received messages while the lower level operation can include at least one of plural sub functions of replaying, rewinding, fast-forwarding, skipping, deleting and storing a message, which appertain to the main function.

The lower level operation can be based on a format to store a message, and the apparatus further comprises a data manipulation unit configured to modify the message in the format corresponding to the lower level operation.

The apparatus can further include a communication unit configured to engage with the mobile device through a local area wireless network.

The upper level operation and the lower level operation activated by the voice instruction and the non-voice input can be used for running a vehicle engagement application installed in the mobile device.

The non-voice input can be delivered via the mobile device.

The controller is configured to determine which upper level operation corresponds with the voice instruction, determine a factor, which is not recognized from or included in the voice instruction but necessary to perform the upper level operation, based on a predetermined set or value, and perform the upper level operation based on the voice instruction and the factor.

The factor can include at least one of information regarding a time, a date, a place and a sender, when the upper level operation can include playing received messages.

An apparatus for controlling an apparatus included in a vehicle with a voice recognition device can include a processing system that comprises at least one data processor and at least one computer-readable memory storing a computer program. Herein, the processing system can be configured to cause the apparatus to receive and recognize a voice instruction, perform an upper level operation corresponding to the voice instruction, receive a non-voice input for performing a lower level operation appertaining to the upper level operation, and perform the lower level operation in response to the non-voice input.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A and 1B show a plausible problem caused by a voice recognition device equipped in a vehicle;

FIG. 2 shows a method for controlling an electric device equipped in a vehicle based on a voice recognition device;

FIGS. 3A and 3B show a message managing device using both a voice instruction and a non-voice instruction;

FIG. 4 describes a time section for receiving a non-voice instruction;

FIGS. 5A and 5B show a data manipulation method for using both a voice instruction and a non-voice instruction; and

FIG. 6 shows an apparatus for controlling an electric device equipped in a vehicle based on a voice recognition device.

### DETAILED DESCRIPTION

Reference will now be made in detail to the preferred embodiments of the invention, examples of which are illustrated in the accompanying drawings. In the drawings, the same elements are denoted by the same reference numerals, and a repeated explanation thereof will not be given. The suffixes “module” and “unit” of elements herein are used for convenience of description and thus can be used interchangeably and do not have any distinguishable meanings or functions.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

In the description of the invention, certain detailed explanations of related art are omitted when it is deemed that they may unnecessarily obscure the essence of the invention. The features of the invention will be more clearly understood from the accompanying drawings and should not be limited by the accompanying drawings. It is to be appreciated that all changes, equivalents, and substitutes that do not depart from the spirit and technical scope of the invention are encompassed in the invention.

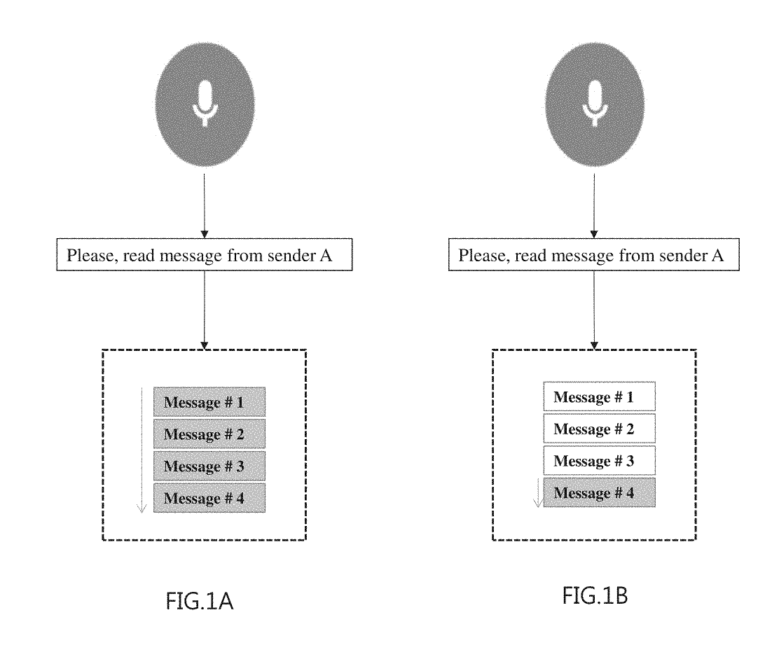

FIGS. 1A and 1B show a plausible problem caused by a voice recognition device equipped in a vehicle. FIGS. 1A and 1B illustrate a situation incurred when a massage management device uses a voice recognition device in a vehicle. Particularly, FIG. 1A shows a situation when received messages are checked through Apple's voice recognition device (e.g., SiRi) and Apple's vehicle engagement application (e.g., Apple CarPlay), while FIG. 1B is a case of using Google's voice recognition device and Google's vehicle engagement application (e.g., Android Auto).

As shown, Apple CarPlay and Android Auto described in FIG. 1A and FIG. 1B can receive only voice instructions while they deliver, or respond to, user's voice instructions. Herein, Apple CarPlay and Android Auto can analyze voice instructions inputted from a user or a driver, and perform corresponding operations. However, in this procedure, if a non-voice input or instruction is given via a button or a touch screen, it is stopped to control an apparatus via the voice instructions. Accordingly, when a user or a driver would like to use voice instructions after the non-voice input is delivered, he or she should enter voice instructions again, and Apple CarPlay and Android Auto can be operated again at the beginning stage.

Referring to FIG. 1A, an operation of Apple CarPlay is described. When a voice instruction “Please, read a message from a sender A” is entered by a user (or a driver) via a microphone, Apple CarPlay can recognize the voice instruction and then perform an operation corresponding to the recognized voice instruction. Among messages received by a message management device, Apple CarPlay collects only messages delivered from the sender A and reads all of the collected messages. If the number of the collected messages is 4 (i.e., there are first to fourth collected messages #1, #2, #3, #4), Apple CarPlay can read the first to fourth collected messages in order. Even though a user (or a driver) would like to listen to only the fourth message #4, Apple CarPlay does not provide additional interface to play the fourth message #4 only. Accordingly, a user or a driver has to listen to the other three messages #1, #2, #3 before hearing the fourth message #4.

Referring to FIG. 1B, an operation of Android Auto is described. When a voice instruction “Please, read a message from a sender A” is entered by a user (or a driver) via a microphone, Android Auto can recognize the voice instruction and then read only the last message among all of the messages delivered from the sender A.

Further, in Apple CarPlay and Android Auto, if a user or a driver would like to listen to a particular message again, he or she should enter the voice instruction “Please, read a message from a sender A” again.

When a user or a driver uses a voice instruction through Apple CarPlay and Android Auto, some operations can be limited because of several reasons. While the voice instruction may be one of means which a user or a driver can input the most conveniently, he or she can have different tones, accents, habits or the like to use his or her natural languages. To recognize a voice instruction including user's or driver's complex needs, a voice recognition device can require a lot of resources. However, either a mobile device or a vehicle can assign limited sources to the voice recognition device. Thus, a system, an apparatus or a software application such as Apple CarPlay and Android Auto, which can engaged with a vehicle, can only recognize simple voice instructions. An operation corresponding to the simple voice instructions can be limited in a predetermined way.

In a situation when controlling an electric device via voice instructions fails to meet user's complex needs, a user can feel inconvenience and he or she can evade using a voice recognition device. In order to overcome issues described above, a method and an apparatus for using a voice instruction recognized by a voice recognition device with a non-voice input given via conventional user interfaces (e.g., a button, a touch screen, or the like) can be used to control an electric device conveniently.

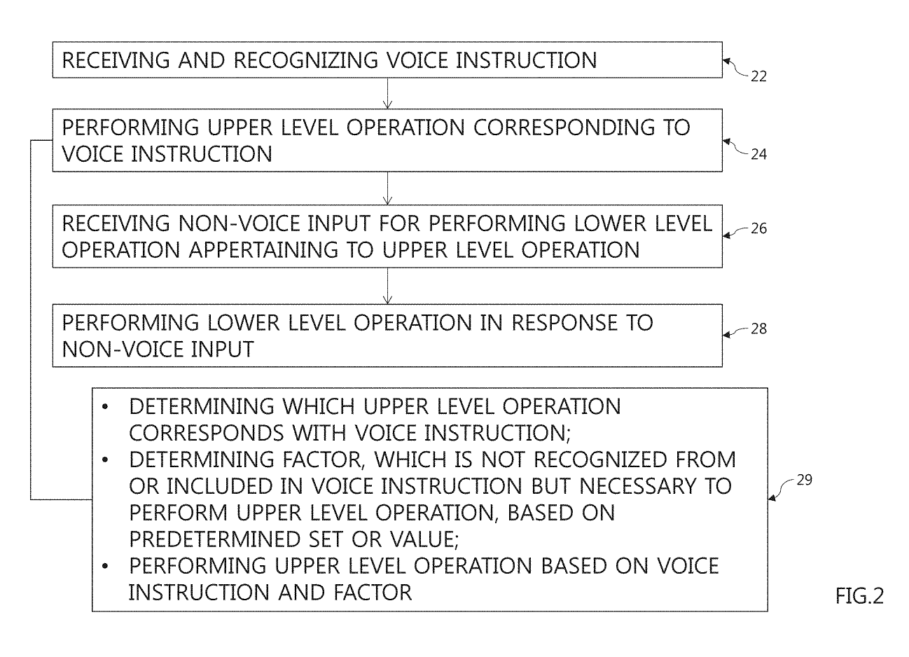

FIG. 2 shows a method for controlling an electric device equipped in a vehicle based on a voice recognition device.

As shown, a method for using a voice recognition device to control an apparatus can include receiving and recognizing a voice instruction (step 22), performing an upper level operation corresponding to the voice instruction (step 24), receiving a non-voice input for performing a lower level operation appertaining to the upper level operation (step 26), and performing the lower level operation in response to the non-voice input (step 28).

The upper level operation can include a function performed by a voice instruction, while the lower level operation can include a sub function which is difficultly performed by the voice instruction. The lower level operation can be limited to include only functions falling within coverage of the upper level operation. Operations or functions provided by an electric device controlled by a voice recognition device can be split into the upper level operation and the lower level operation according to its attribute, or be adjusted based on a design of the electric device or a request from a user using the voice recognition device. Particularly, the upper and lower level operations can have a dominant-subordinate relationship. The upper level operation cannot be finished before the lower level operation is not completed, and the lower level operation cannot be performed before the upper level operation is carried on.

By way of example but not limited to, it is assumed that a message management device is controlled by a voice recognition device. When the upper level operation is a function of playing received messages, the lower level operation can be one of plural functions of replaying, rewinding, fast-forwarding, skipping, deleting and storing a message, which are relevant to the function of playing received messages.

Herein, the non-voice input can be given via a button or a touch screen equipped in a vehicle. Further, the non-voice input is recognized after the voice instruction is recognized until the upper level operation is completely done.

As not shown, the method for using the voice recognition device to control the apparatus can further include receiving a new non-voice input for performing any lower level operation appertaining to the upper level operation until the upper level operation is finished after the previous lower level operation is done.

Further, the performing an upper level operation (step 240 can include at least one of determining which upper level operation corresponds with the received voice instruction (step 29), determining a factor, which is not recognized from or included in the voice instruction but necessary to perform the upper level operation, based on a predetermined set or value (step 29), and performing the upper level operation based on the received voice instruction and the factor (step 29). When the upper level operation is a function of playing received messages, the considerable factor can include at least one of information regarding a time, a date, a place and a sender.

By way of example but not limited to, it is assumed that a voice instruction recognized by a voice recognition device is “Please, read a message from a sender A.” Except for the sender A, received messages in a message management device can be classified based on a factor such as this week, yesterday, today, the last month, a specific date, and so on. If recognized voice instruction does not include information about the above described factor, a predetermined value regarding the factor can be applicable. If it is previously set that messages only received in the last week are played while a voice instruction about playing received messages is given, an electric device operated by a voice recognition device can read only messages delivered in the last week among all of the messages from the sender A when a voice instruction “Please, read a message from a sender A” is inputted.

Herein, determining a factor not included in the voice instruction according to a predetermined value or set can become effective as a voice recognition device cannot handle or recognize a complex voice instruction.

As not shown, the method for using the voice recognition device to control the apparatus can further include engaging with a mobile device through a local area wireless network. Since it is not easy to add or modify resources in a vehicle, unlike in a mobile device, the vehicle can use resources for voice recognition, which are equipped in the mobile device. Further, because a resource which the vehicle cannot provide can be provided by the mobile device, an IT service via the mobile device engaged with the vehicle can be available for a user (or a driver) as long as the IT service doesn't affect driving safety.

Further, both the upper level operation and the lower level operation performed by the voice instruction and the non-voice input can be for running a vehicle engagement application installed in the mobile device. A driver (or a user) can use or control software, applications or devices which are equipped in the vehicle as well as provided by the mobile device engaged with the vehicle.

The method for using the voice recognition device to control the apparatus can further include receiving a voice instruction or a non-voice input via the mobile device. Though user's (or driver's) voice instruction can be given via a microphone equipped in the vehicle, the mobile device engaged with the vehicle can be an input device for voice instruction when the vehicle does not include the microphone, the equipped microphone is not available, or the like.

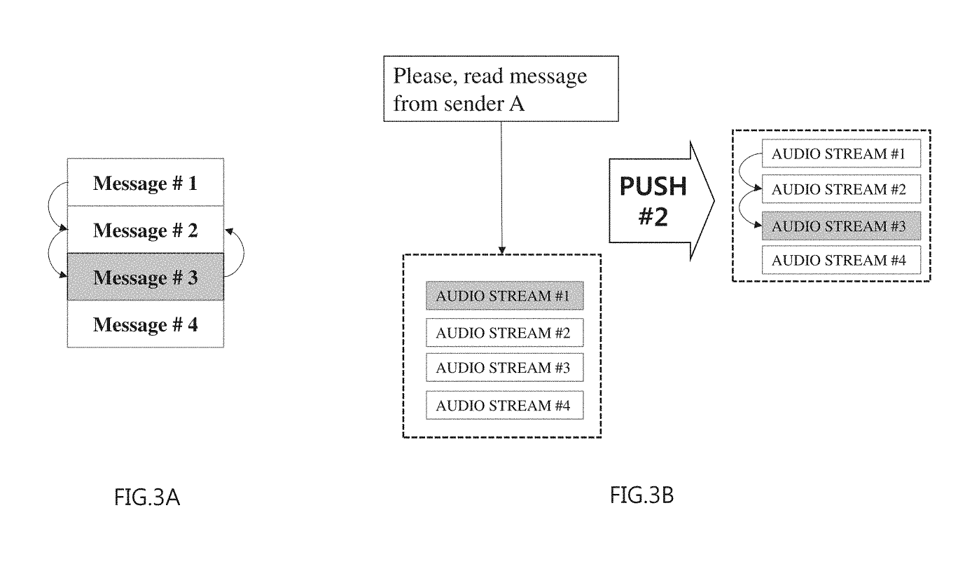

FIGS. 3A and 3B show a message managing device using both a voice instruction and a non-voice instruction. Particularly, FIG. 3A describes a lower level operation of the message managing device in response to the voice instruction and the non-voice instruction, while FIG. 3b shows examples comparing cases having the non-voice instruction and no non-voice instruction.

Referring to FIG. 3A, it is assumed that a voice instruction for requesting received messages delivered by a sender A is inputted. When the number of the received messages from the sender A is 4, an apparatus can play all of the received messages #1, #2, #3, #4 in response to the voice instruction. But, in a case of using a non-voice instruction, if a first message #1 is not the one which a user would like to listen to, the user can press a button (e.g., a ‘Seek Up’ button) for playing the next message, i.e., a second message #2 (e.g., a ‘forward’ function). If the user would like to skip the second message #2, he or she can press the button (e.g., a ‘Seek Up’ button) again for moving to a third message #3 so that the apparatus can play the third message #3. If the user would like to hear the second message #2 after listening to the third message #3, he or she can push another button (e.g., ‘Seek Down’ button) for moving to the second message #2 so that the apparatus can play the second message #2 (e.g., a ‘rewind’ function).

When using a voice instruction as well as a non-voice instruction, the non-voice instruction (e.g., a button input) given while an operation in response to the voice instruction (e.g., playing requested messages) is performed can control sub-functions without terminating the operation corresponding to the voice instruction.

Referring to FIG. 3B, if a voice instruction “Please, read a message from a sender A” is inputted, a voice recognition device can recognize the voice instruction. While the voice recognition device recognizes and analyzes the voice instruction, an apparatus can perform an indexing operation regarding words which a user does not most likely perceive or audio stream information (e.g., time, date, place, and so on).

An electric device or application program equipped in, or engaged with, a vehicle can output an operation result in response to a recognized voice instruction. When there are four audio streams #1, #2, #3, #4 in response to the voice instruction, a first audio stream #1 can be played if there is no non-voice input. However, if the number ‘2’ is entered via a button, a touch screen or the like, the electric device or application program can skip two audio streams #1, #2 and play a third audio stream #3.

While playing an audio stream, a control apparatus can determine whether requested audio data is split into plural streams or provided as a single stream. If the audio data is split into plural streams, the control apparatus can communicate with a voice recognition device (e.g., a server, a Siri, and so on) so as to obtain data streams corresponding to an index. Herein, each audio stream can be collected and modified as a single continuous stream with an index or a tag. Accordingly, a user or a driver can reduce voice instruction input times while loads for voice recognition in the control apparatus can be decreased. Further, in response to a voice instruction, the control apparatus can perform an operation or search a result fast.

As above described, when a non-voice instruction is entered by a user while an operation result is outputted, the control apparatus can demand an audio stream corresponding to the non-voice instruction on an in-vehicle electric device or an application program engaged with a vehicle.

Further, in the control apparatus, a standby status for voice recognition may not be terminated even after a fourth audio stream #4 is played completely.

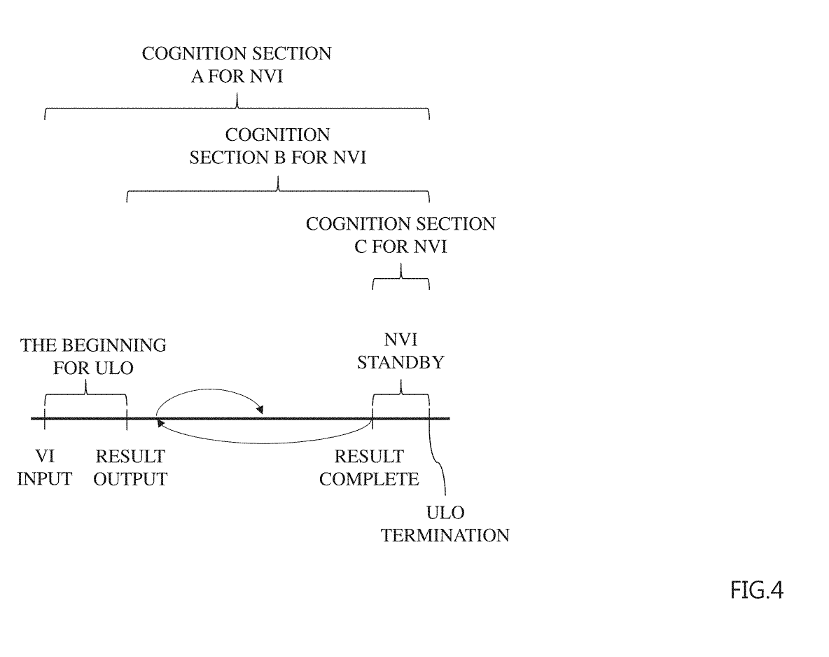

FIG. 4 illustrates a time section for receiving a non-voice instruction.

As shown, a cognition section A, B, C for a non-voice instruction can be changed according to a system design or resources equipped in the system.

When entered, a voice instruction (VI) can be recognized by a voice recognition device. An upper level operation (ULO) in response to the recognized voice instruction is performed, and an operation result is outputted. The upper level operation can be terminated a predetermined time after all of the operation result is outputted. These procedures for the upper level operation can be split into several sections: a beginning section from a timing of recognizing a voice instruction to a timing of outputting an operation result; an outputting section from the timing of outputting the operation result to a timing of completing the operation result; and a non-voice instruction standby section from the timing of completing the operation result to a timing of terminating the upper level operation.

According to a system design, resources, stability or the like, a non-voice instruction (NVI) for performing a lower level operation appertaining to the upper level operation can be entered in the cognition section A which is from the timing of recognizing the voice instruction to the timing of terminating the upper level operation. In another embodiment, the non-voice instruction can be recognized in the cognition section B which is from the timing of outputting the operation result to the timing of terminating the upper level operation. Further, in another embodiment, the non-voice instruction can be entered in the cognition section C which is from the timing of completing the operation result to the timing of terminating the upper level operation.

By way of example but not limited to, when an electric device outputs an audio data having a long play time, a user or a driver can push a button (e.g., a Seek Up or Seek Down button) in order to move forward or back a predetermined time (e.g., 2 seconds). The upper level operation cannot be terminated directly after all of the audio data is completely outputted, but have a standby section for another non-voice instruction delivered from a user. During the standby section, if a user or a driver pushes a button (e.g., a Seek Down button) two times, the control apparatus moves back 4 seconds (e.g., two times of 2 seconds), and the electric device can play a corresponding portion of the audio data again.

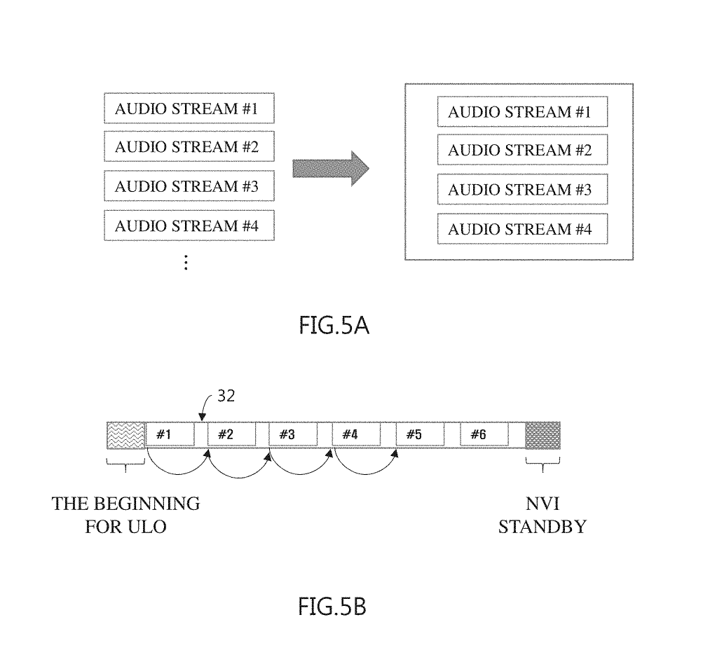

FIGS. 5A and 5B show a data manipulation method for using both a voice instruction and a non-voice instruction.

Referring to FIGS. 5A and 5B, a result of an upper level operation in response to a voice instruction can be formed in an audio stream.

By way of example but not limited to, an audio stream can be divided into and provided by several portions. The audio stream if split into several portions can be played again without entering a voice instruction again or accessing a buffer which can store each portion of the audio stream individually. However, in order to move forward or back in a combined stream in response to a non-voice instruction, the combined stream can include a blank section, a tag, etc. for indicating a play point in the combined stream so that a user can play or listen to a desired portion only. Further, when a large audio stream is played, a user can use a button or a key to move forward or back to a desired point such as the beginning, the middle, the end or the like.

Referring to FIG. 5A, it is assumed that, if a voice instruction is entered, first to fourth audio streams #1, #2, #3, #4 can be found as an operation result of an upper level operation corresponding to the voice instruction. The first to fourth audio streams can be coupled sequentially as a single big data stream.

Referring to FIG. 5B, it can be assumed that plural results (e.g., first to sixth audio streams #1, #2, #3, #4, #5, #6) are coupled in a form of a big data stream. The big data stream can include an indicator 32 (e.g., an index, a tag, or the like). Herein, the indicator 32 can be added at the beginning or the end of the plural results (e.g., first to sixth audio streams #1, #2, #3, #4, #5, #6), and used for performing a lower level operation appertaining to the upper level operation. Further, in the big data stream, a void data can be further complemented for at least one of the beginning section of the upper level operation (shown in FIG. 4) and the standby section for a non-voice instruction (referring to FIG. 4). By way of example but not limited to, if the void data for the standby section is added in the big data stream, a non-voice instruction can be recognized while an audio stream (i.e., an operation result) is played as well within a predetermined time after the audio stream is completely played.

In a case when operation results can be combined in a single stream, plural audio streams provided individually from at least one apparatus which is a device such as an electric device or application configured to perform an upper level operation to output results can be stored in a separate storage such as an audio buffer. If the separate storage stores operation results obtained from plural apparatuses, a control apparatus can control how to output the operation results to a user or a driver in detailed without further communicating with the plural apparatuses.

According to a data manipulation method for using a voice instruction and a non-voice instruction, there can be many types of data or stream stored in a buffer, such as a combined form, a unitary form, a complex form, or the like. For example, the combined form is a type of combining several short-length audio streams outputted from plural apparatuses into a single steam, while the unitary form is a type of a single large stream outputted from each apparatuses. The complex form is a mixed type of the combined form and the unitary form. In the combined form, moving forward or back can be achieved every short-length audio stream. However, in the unitary form, moving forward or back can be achieved a predetermined time or a predetermined data size. When the complexed form is used, moving forward or back can be available to every short-length audio stream, every predetermined time or every predetermined data size.

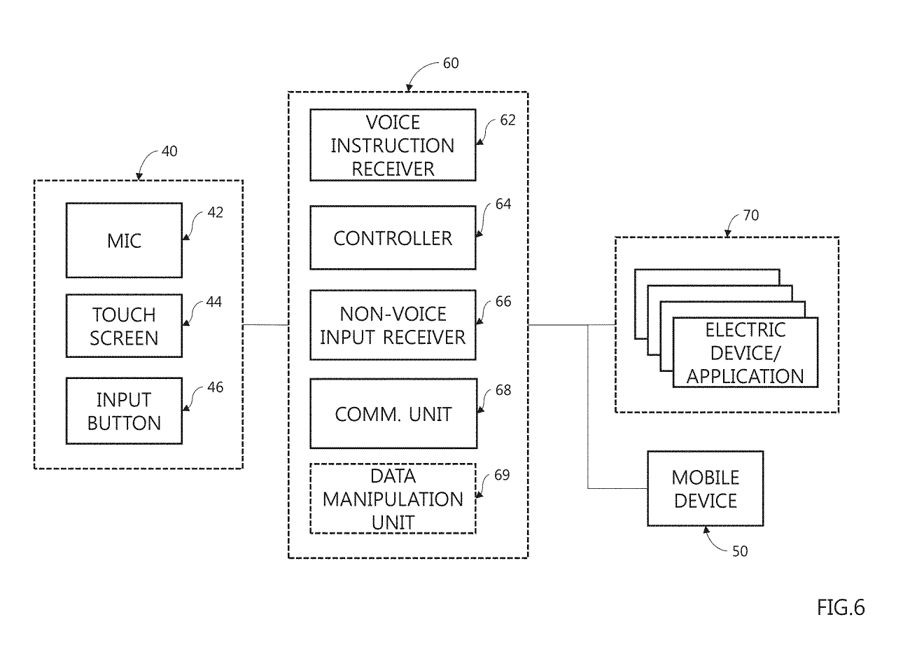

FIG. 6 shows an apparatus for controlling an electric device equipped in a vehicle based on a voice recognition device.

As shown, a control apparatus 60 provided for controlling an apparatus included in a vehicle can include, or be engaged with, a voice recognition device. Herein, the control apparatus 60 can include a voice instruction receiver 62 configured to receive and recognize a voice instruction used for running or controlling an electric device equipped in, or engaged with, a vehicle, a controller 64 configured to perform an upper level operation according to the voice instruction, and a non-voice input receiver 66 configured to receive a non-voice input used for performing one of lower level operations appertaining to the upper level operation. In response to the non-voice input, the controller 54 can further perform the lower level operation.

The control apparatus 60 can be engaged with several interfaces 40 equipped in the vehicle, or include the several interfaces 40. By way of example but not limited to, the interfaces 40 equipped in the vehicle can further include a microphone 42 configured to deliver the voice instruction, a touch screen 44 or a button 46 configured to deliver the non-voice instruction, and the like.

The non-voice input can be entered via the touch screen 44 or the button 46 after the voice instruction is recognized until the upper level operation is completely done.

Because of a standby section for the non-voice input, the upper level operation can be maintained for a predetermined time after the lower level operation is done, and can be terminated when the predetermined time lapses after the lower level operation is done. The non-voice input receiver 66 can recognize a new non-voice input for performing any lower level operation appertaining to the upper level operation until the upper level operation is finished after the previous lower level operation is done.

While the upper level operation is a main function of playing received messages, the lower level operation can be at least one of plural sub functions of replaying, rewinding, fast-forwarding, skipping, deleting and storing a message, which appertain to the main function. Further, when an operation result of the upper level operation includes an audio stream, the lower level operation can include movement or repetition for a predetermined time or user's request time while the operation result is played.

The lower level operation can be different based on a format of how to store a message. Herein, the control apparatus 60 can further include a data manipulation unit 69 configured to modify the message in the format corresponding to the lower level operation. The data manipulation unit 69 can further include a buffer or a storage unit for temporarily storing manipulated or modified data.

Further, the control apparatus 60 can include a communication unit 68 configured to engage with a mobile device 50 through a local area wireless network.

The upper level operation and the lower level operation handled by the control apparatus 60 in response to the voice instruction and the non-voice input can be used for running a vehicle engagement application installed in the mobile device 50.

Further, a microphone, a button, a touch screen equipped in the mobile device 50, not included in the interfaces 40 equipped in the vehicle, can deliver the voice instruction and the non-voice input into the control apparatus 60.

Further, the controller 64 can determine which upper level operation corresponds with the voice instruction, determine a factor, which is not recognized from or included in the voice instruction but necessary to perform the upper level operation, based on a predetermined set or value, and perform the upper level operation based on the voice instruction and the factor. If the upper level operation includes playing received messages, the factor can include at least one of information regarding a time, a date, a place and a sender.

The control apparatus 60 with the voice recognition device for using a voice instruction as well as a non-voice instruction can promptly provide an audio result requested by a user and he or she can selectively listen to some of the audio result. Further, the control apparatus 60 can provide a function of repetition about some of the audio result, or control a play speed about a long-length audio result. The control apparatus 60 with the voice recognition device can reduce a communication overhead for voice instruction as well as input times for voice instruction. Even after outputting audio result is complete, the control apparatus 60 can provide a sub-function in response to a non-voice instruction because of a standby time for the non-voice instruction.

When using a voice recognition device to check received messages, a user or a driver can search and select a message among the received messages fast, listen to it again after hearing it, and skip over some messages before it.

Further, because it is not required for a user to input complex voice instructions for a specific operation, an electric apparatus in a vehicle, which includes or engages with a voice recognition device, can reduce its operational loads and equipped resources used to recognize the complex voice instructions inputted from a user.

Since a user or a driver inputs at least one voice instructions with other user interfaces, a specific operation upon his or her request can be performed efficiently in an in-vehicle electric apparatus.

The aforementioned embodiments are achieved by combination of structural elements and features of the invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the invention. The order of operations described in the embodiments of the invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet).

It will be apparent to those skilled in the art that various modifications and variations can be made in the invention without departing from the spirit or scope of the inventions. Thus, it is intended that the invention covers the modifications and variations of this invention provided they come within the scope of the appended claims and their equivalents.

What is claimed is:

1. A method for controlling an apparatus included in a vehicle with a voice recognition device, comprising:
receiving and recognizing a voice instruction;
performing an upper level operation corresponding to the voice instruction;
receiving a non-voice input for performing a lower level operation appertaining to the upper level operation; and
performing the lower level operation in response to the non-voice input.

2. The method according to claim 1, wherein the non-voice input is recognized after the voice instruction is recognized until the upper level operation is complete.

3. The method according to claim 1, wherein the upper level operation is not finished within a predetermined time after the lower level operation is complete.

4. The method according to claim 3, further comprising:
receiving a new non-voice input for performing another lower level operation appertaining to the upper level operation within the predetermined time after the lower level operation is complete.

5. The method according to claim 1, wherein the upper level operation includes a main function of playing received messages while the lower level operation includes at least one of plural sub functions of replaying, rewinding, fast-forwarding, skipping, deleting and storing a message, which appertain to the main function.

6. The method according to claim 1, further comprising:
engaging with a mobile device through a local area wireless network; and
receiving at least one of the non-voice input and the voice instruction via the mobile device.

7. The method according to claim 6, wherein the upper level operation and the lower level operation activated by the voice instruction and the non-voice input are for running a vehicle engagement application installed in the mobile device.

8. The method according to claim 1, wherein the performing the upper level operation comprises:
determining which upper level operation corresponds with the voice instruction;
determining a factor, which is not recognized from or included in the voice instruction but necessary to perform the upper level operation, based on a predetermined set or value; and
performing the upper level operation based on the voice instruction and the factor.

9. The method according to claim 8, wherein the factor includes at least one of information regarding a time, a date, a place and a sender, when the upper level operation includes a function of playing received messages.

10. An apparatus for controlling an apparatus included in a vehicle with a voice recognition device, comprising:
a voice instruction receiver configured to receive and recognize a voice instruction used for controlling an electric device equipped in, or engaged with, the vehicle;
a controller configured to perform an upper level operation according to the voice instruction; and
a non-voice input receiver configured to receive a non-voice input for performing a lower level operation appertaining to the upper level operation,
wherein the controller performs the lower level operation in response to the non-voice input.

11. The apparatus according to claim 10, further comprising:
a microphone configured to deliver the voice instruction; and
at least one of a touch screen and a button configured to deliver the non-voice instruction.

12. The apparatus according to claim 10, wherein the non-voice input is recognized after the voice instruction is recognized until the upper level operation is complete.

13. The apparatus according to claim 10, wherein the upper level operation is not finished within a predetermined time after the lower level operation is complete.

14. The apparatus according to claim 13, wherein the non-voice input receiver recognizes a new non-voice input for performing any lower level operation appertaining to the upper level operation within the predetermined time after the lower level operation is complete.

15. The apparatus according to claim 10, wherein the upper level operation includes a main function of playing received messages while the lower level operation includes at least one of plural sub functions of replaying, rewinding, fast-forwarding, skipping, deleting and storing a message, which appertain to the main function.

16. The apparatus according to claim 15, wherein the lower level operation is based on a format to store a message, and the apparatus further comprises a data manipulation unit configured to modify the message in the format corresponding to the lower level operation.

17. The apparatus according to claim 10, further comprising:
a communication unit configured to engage with the mobile device through a local area wireless network,
wherein at least one of the non-voice input and the voice instruction is delivered via the mobile device.

18. The apparatus according to claim 17, wherein the upper level operation and the lower level operation activated by the voice instruction and the non-voice input are for running a vehicle engagement application installed in the mobile device.

19. The apparatus according to claim 10, wherein the controller is configured to:
determine which upper level operation corresponds with the voice instruction;
determine a factor, which is not recognized from or included in the voice instruction but necessary to perform the upper level operation, based on a predetermined set or value; and
perform the upper level operation based on the voice instruction and the factor.

20. The apparatus according to claim 19, wherein the factor includes at least one of information regarding a time, a date, a place and a sender, when the upper level operation includes playing received messages.
